(19) United States
(12) Patent Application Publication
(10) Pub. No.: US 2014/0278663 A1
(43) Pub. Date: Sep. 18, 2014

(54) ELECTRONIC DISCOVERY SYSTEMS AND WORKFLOW MANAGEMENT METHOD

(71) Applicant: EXTERRO, INC., TIGARD, OR (US)

(72) Inventors: Ajith Samuel, Beaverton, OR (US); Ganesh Shankar, Beaverton, OR (US); Arun Sivakumar, Coimbatore (IN); Gopi Thulasidoss, Coimbatore (IN); Ramesh Kumar, Coimbatore (IN); Bobby Balachandran, Beaverton, OR (US); Karthik Palani, Beaverton, OR (US); Shashidhar Angadi, Beaverton, OR (US)

(73) Assignee: EXTERRO, INC., TIGARD, OR (US)

(21) Appl. No.: 14/211,413

(22) Filed: Mar. 14, 2014

Related U.S. Application Data
(60) Provisional application No. 61/800,629, filed on Mar. 15, 2013.

(51) Int. Cl. G06Q 10/06

(52) U.S. Cl. CPC G06Q 10/063118; G06Q 10/0633
USPC 705/7.17

(57) ABSTRACT

Various systems and methods for managing electronic discovery are provided. In one example, a method for facilitating a cross-team, role-based workflow for task management on a computing device comprises sending a project request to a business coordinator, the project request received from a legal/compliance team member, assigning work required by the project request to a discovery coordinator based on input received from the business coordinator, and performing the work required by the project request by assigning one or more projects to one or more collection/preservation teams based on input received from the discovery coordinator.

### CROSS REFERENCE TO RELATED APPLICATIONS

This application claims priority to U.S. Provisional Patent Application No. 61/800,629, entitled “ELECTRONIC DISCOVERY SYSTEMS AND METHOD,” filed Mar. 15, 2013, the entire contents of which are hereby incorporated herein by reference for all purposes.

### BACKGROUND AND SUMMARY

During or in anticipation of a litigation, parties to a litigation may be required to preserve and eventually produce documents in their possession that relate to the litigation. Documents to be preserved are known as being subject to a legal hold. Documents may exist in electronic form in computer systems or electronic storage devices. One element of electronic discovery (e-discovery) involves obtaining a thorough set of relevant documents from those computer systems and electronic storage devices. When there are a large number of documents contained in one or more computer systems, the manual discovery process can be very cumbersome. Compliance with a legal hold requires a thorough search of the computer systems and electronic storage devices. However, at least for reasons of cost management, privacy, and confidentiality, parties want to avoid producing documents that are not relevant to the litigation. Therefore, a final determination of a document's relevance to the litigation is usually made by a manual review process. The expense of this process is related to the number of documents reviewed. While each step in a typical e-discovery workflow process may be designed to reduce the number of documents to be reviewed, a lack of coherence in the process may create the possibility of failure and/or the loss of data, which can result in additional cost needed to recover data and/or sanctions for failing to produce relevant data.

To reduce the expense of e-discovery, computer software may be used to automatically search for and retrieve relevant documents. Typically, the software will search for emails or documents containing the keywords or names provided by users or individuals related to the litigation. The names and keywords used in the search are identified by the parties or people managing the case. However, the results of such searches are limited by the keywords, names, or other information supplied by the users.

Accordingly, various embodiments are disclosed herein that relate to systems and methods for performing electronic discovery, including identifying, collecting, processing and managing documents subject to a legal hold. In this context, some embodiments relate to hold notification communications to custodians. Some relate to efficiently identifying a set of relevant documents. Some relate to simplified collection, such as through a single user input, of legal hold data. Some relate to integration with Human Resources (HR) data and security or other systems in the enterprise environment. Some relate to user interfaces displaying a unique set of e-discovery information in a specialized configuration. Some relate to a work-flow approach carried out during the operation of the system.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 schematically shows an exemplary system in which a corpus of documents may be contained in accordance with an embodiment of the present disclosure.

FIG. 2 schematically shows an exemplary enterprise management system in accordance with an embodiment of the present disclosure.

FIGS. 3A & 3B respectively show an exemplary dashboard and a GUI in accordance with an embodiment of the present disclosure.

FIG. 4 shows another exemplary GUI in accordance with an embodiment of the present disclosure.

FIG. 5 shows a flowchart illustrating a method for preserving data in accordance with an embodiment of the present disclosure.

FIG. 6 shows a flowchart illustrating a method for performing data collection as part of a legal hold in accordance with an embodiment of the present disclosure.

FIG. 7 shows a flowchart illustrating a method for issuing custodian notifications based on publication parameters in accordance with an embodiment of the present disclosure.

FIG. 8 shows a flowchart illustrating a method for facilitating a cross-team, role-based workflow for task management in accordance with an embodiment of the present disclosure.

FIG. 9 shows a flowchart illustrating a method for creating a project request in accordance with an embodiment of the present disclosure.

FIG. 10 shows a flowchart illustrating a method for managing projects in accordance with an embodiment of the present disclosure.

### DETAILED DESCRIPTION

Electronic files may correspond to various file types, including but not limited to an email, text message, distribution list, spreadsheet, text file, bit map, or graphics file. One of ordinary skill would recognize that other types of electronic files (e.g., electronic documents) may also exist according to embodiments. Electronic documents, as referred to herein, may be accessible by known electronic communications methods and may be stored in a variety of data sources, including but not limited to custodian hard disk drives (HDD) or other types of storage devices, email servers, network shares, etc.

To define the parameters and criteria of a legal hold, a legal team may consider the facts of the case and the parties involved in the events leading up to the case. Based on the locations of these documents, a target corpus of documents to be search may be identified. In some cases, it may be necessary to search through a large number of documents in a large storage area to find a few documents containing relevant information. The storage area to be searched may be identified by physical storage devices, logical storage partitions, document security designations, or by any other means known to one of ordinary skill in the art. A large search scope increases the potential for finding relevant documents but may require a prohibitively large search time and expense. The entire corpus of documents may be searched for documents that are relevant to the litigation, and a manual review of every document in the corpus could be a long and laborious process. Effectively filtering or culling the corpus may reduce the quantity of documents that need to be reviewed. Documents not meeting the search criteria may not be reviewed. In embodiments, the corpus of documents may be contained within a single computer or storage device, or the corpus of documents may be spread across multiple servers, client computers, storage devices and other components that may or may not be interconnected. For example, the corpus of documents may be stored in a hosted user environment utilizing distributed storage.

Accordingly, systems and methods for managing electronic discovery are provided. In one example, a method for facilitating a cross-team, role-based workflow for task management on a computing device comprises sending a project request to a business coordinator, the project request received from a legal/compliance team member, assigning work required by the project request to a discovery coordinator based on input received from the business coordinator, and performing the work required by the project request by assigning one or more projects to one or more collection/preservation teams based on input received from the discovery coordinator.

FIG. 1 is schematically shows an exemplary system 100 in which a corpus of documents may be contained, according to an embodiment of the present disclosure. The corpus of documents may include electronically stored information (ESI). Although system 100 is described herein with respect to a limited number of devices and a single network, one of ordinary skill in the art will recognize that a system containing relevant documents may include different numbers of components and other types of components than those shown. In addition, the system components may be standalone or may be interconnected by one or more networks of various types.

System 100 of FIG. 1 is provided as a non-limiting example for explanation purposes. System 100 includes computing devices, such as server 120 and 122, and client computers 102, 104 and 106. System 100 also includes storage devices 110 and 112. The devices in system 100 are interconnected by network 130. Network 130 may be a local area network (LAN), wide area network (WAN), intranet, internet, Wi-Fi, cell phone network, or any other wired or wireless network for communication between computing devices. One of ordinary skill in the art would recognize that there are many possible variations on the number and interconnection of computing and storage devices in which all or part of the corpus of documents could be contained and searched according to embodiments.

Utilizing one or more computing devices, the corpus of documents may be searched for potentially relevant documents. In system 100, a search may be initiated, for example, at client computer 102. The corpus of documents may be isolated to documents stored within client computer 102. Additionally, or alternatively, the corpus may include documents contained within, e.g., storage device 110 and/or server 120. When a search is performed, information about each document or set of documents in the corpus of documents may be obtained. This information is compared to a set of search criteria that has been prepared in response to the legal hold. The search criteria may include several types of information used to identify potentially relevant documents. For example, the names, locations, creation dates, modification dates, other date ranges, etc. of documents satisfying the search criteria may be returned in the search results. The actual documents may also be returned, or links may be provided to individual documents. Other sets of search results are possible.

FIG. 2 schematically shows an exemplary enterprise management system 200 according to an embodiment of the present disclosure. The system includes a plurality of software routines or modules 204 included on a computing device 202, and in one example, may be an electronic discovery management server. Computing device 202 may interface with system 100 described above in which a corpus of documents may be contained. Further, computing device 202 may interface with one or more 3rd party or other applications 222. As shown, network 130 may communicatively couple system 100 to enterprise management system 200 as well as their subcomponents.

As shown, computing device 202 includes a processor 201 and memory 203. It will be appreciated, however, that computing device 202 may include two or more processors. Memory 203 comprises a storage device 205, which together may form a memory/storage hierarchy comprising, for example, one or more of optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. The memory hierarchy may include volatile, nonvolatile, dynamic, static, read/write, read-only, random-access, sequential-access, location-addressable, file-addressable, and/or content-addressable devices. Memory 203 may comprise two or more storage devices 205, however. Processor 201 may be configured to access non-transitory data stored on memory 203 and/or storage device 205 and execute instructions stored thereon. In some embodiments, the plurality of modules 204 may be stored on storage device 205, for example.

In some examples, computing device 202 may be included in system 100, behind a firewall, for example, so that modules 204 may be accessed by one or more client devices within system 100. As another example, computing device 202 may be a server residing on the internet so that the plurality of modules 204 is stored in a cloud-based environment. One or more client devices included in system 100 may be configured to access one or more modules in the plurality of modules 204. Further, in some examples, one or more modules in the plurality of modules may be included on one or more client devices in system 100.

By way of example, the plurality of modules 204 includes a visualization module 206 for displaying information, examples of which being described herein, a project manager 208, a legal hold manager 210 including an interview manager 211, a custodian manager 212, a data mapping module 214 which stores information in a data map database 216, a predictive module 218, ESI collection and processing module 213, ESI analyzer 217, ESI production module 219, and review and processing manager 224. Further, enterprise management system 200 may be configured to interface with various third party or other applications 222 and/or with internal and legacy systems 221, e.g., for integration with active directory (AD) and/or other current information technology (IT) investments, matter management systems, software by RECOMMIND, etc. Finally, enterprise management system may interface with an human resources (HR) database 226. As described in further detail below, HR database 226 may store one or more parameters each with a plurality of custodians such that actions described herein may be taken in response to the one or more parameters and changes thereto. It should be understood that the plurality of modules 204 may include additional functionality associated with the enterprise management system, examples of which are described below. Further, it will be appreciated that modules in the plurality of modules 204 other than data mapping module 214 and predictive module 218 may be communicatively coupled to one or more storage devices as well.

Enterprise management system 200 may perform a variety of functions relating to managing workflows for various e-discovery applications and tools, and provides a common platform to enable different e-discovery applications to work as a unit. Such a common platform can also integrate with information governance tools, such as data management, human resource (HR) systems, archiving applications, and other third party applications (e.g., via third party or other applications 222) for a more streamlined response to e-discovery requests. As described in further detail below, the enterprise management system may use information gathered by an e-discovery hub to facilitate the approaches described herein.

Visualization module 206 may be configured to facilitate visualization of the processes, workflows, and data described herein. To accomplish this visualization, the visualization module may present visual information (e.g., text, graphics including images and video, etc.) in a suitable graphical user interface (GUI). “Dashboard” as used herein may refer to such a GUI used to present visual information and facilitate visualization.

In some examples, visualization module 206 may facilitate intuitive navigation, and real-time, top-down/bottom-up views, of organizational structures and hierarchies, business units, systems such as data sources, and matters, cases, and records. For example, a multidimensional representation of an organizational structure may be presented based on configurable criteria. Litigation profiles may also be presented, and, in some views, data sources may be filtered according to litigation risk, for example to address 26(f) conference negotiation and 30(b)(6) deposition preparations. An executive management console may provide creation and viewing of customized data lists in real-time.

Exemplary dashboards that may be presented by visualization module 206 include a navigation dashboard that may provide an intuitive, user-friendly visual overview of data maps, workflows, and subcomponents. A more specific data map dashboard may allow users to view all changes, trends, and relationships between systems (e.g., data sources) by compliance regulation or system status through a powerful, bird's-eye view reporting function. An EDRM dashboard may present, within and among matters, information, custodians, projects, schedules, and EDRM phases. A discovery landing page or dashboard may help ensure deadlines are met through at-a-glance workflow visibility into custodians, deliverables, issues, notes, and ETA both at overall project levels and at workflow stage levels across multiple matters. Exception reports may be presented, indicating visibility into problem areas that require prompt attention.

Visualization module 206 may also present dashboards and/or other GUIs to particularly facilitate cross-team, role-based workflows such as the workflow shown in FIG. 8. As part of this workflow, the visualization module may facilitate the creation and management of project requests. Generally, the dashboards and GUIs described herein may be customized according to user input. Further, dashboards and GUIs of the present disclosure may implement multi-language support.

Turning now to FIG. 3A, a non-limiting example of a dashboard 300 is shown. As shown, dashboard 300 provides an overview of a matter including respective levels of completion of an EDRM process. For example, the dashboard indicates the number of custodians implicated in the matter, the number of custodians on hold, the amount of ESI collected, the amount of discovered duplicate ESI (labeled in FIG. 3A as “De-duped”), the amount of labeled ESI, and the amount of produced ESI. The dashboard further presents a timeline including several events regarding the matter, in addition to indications of the status of custodian and NCDS legal hold responses. Summaries similar to the legal hold response status summary shown in FIG. 3A may be presented for other aspects relating to the matter including interviews, projects, assessments, collections, and productions. In some examples, access to dashboards and other GUIs presented by enterprise management system 200 may be granted via a single sign-on process for a given user session. In this way, security may be enforced and users may be validated.

FIG. 3B shows a non-limiting example of a GUI 350 related to the matter shown in FIG. 3A. Specifically, GUI 350 shows information regarding a particular custodian, including their last name, first name, global user ID (GUID), title, and department, as well as information regarding ESI associated with the custodian.

Returning to FIG. 2, project manager 208 may be configured to define e-discovery processes and workflows, and manage these processes. The project manager module may facilitate management of components of an automated e-discovery system, including template management by facilitating customization and/or creation of templates that reduce work, minimize errors, and standardize the information collected about electronically stored information. In particular, preformatted customizable templates may be used to create work orders as part of quickly designing e-discovery projects. Projects and work orders may be reused by dragging and dropping customizable specifications. Configurable questionnaires and specification sheets may also be created, for example. The project manager module may further facilitate establishment of preferred project settings that may be provided to a user to assist in project creation.

Project manager 208 may provide project checklists for different states of a given project—for example, at the end of the project. A checklist may ensure that an assigned task is completed according to the checklist specified by the project manager. The project manager may further track, issue, and communicate resolution steps to team members with an advanced messaging system to meet deadlines. In one example, real-time notifications may be received through an SMTP email integration that sends notifications to project managers when events require attention or follow-up.

Project manager 208 may also provide oversight over internal and external service providers' performance. For example, a vendor input portal may facilitate evaluation of vendor service offerings and prices. The vendors may be particularly evaluated based on configurable units of measure that provide an “apples-to-apples” comparison of cost, turnaround times, and ratings. Moreover, the project manager may maintain active service records for all vendors and third party service providers, containing information on the services provided and associated costs. When a project is created, a user can select from among those vendors who perform the service, comparing costs and performance metrics across the list of available vendors.

Project manager 208 may aid in cost/budget management, projection, and estimation. Actual budgets may be forecasted and spending tracked, including variances at the resource level. Template creation described above may include the creation of budget templates for all tasks, matters, and projects with auto-populated cost estimates. Each budget can be easily configured to reflect standard as well as one-of-a-kind costs. Further, projects may be priced out based on accurate data, while cost variance alerts may be provided when cost overruns occur. Flexible resource planning and management capabilities, including multiple units of measure, may help to control costs and avoid project surprises. Cost and budget tracking in this way may support a burdensome cost and cost-shifting argument in court.

Project manager 208 may also assist in process automation to provide a standardized process which facilitates building an evergreen data map. Data source information management may be facilitated by keeping usage and relationship history between data sources and custodians up to date and evergreen, enabling quick deployment of legal holds. More particularly, data source information management may provide details regarding employee ownership of all electronic data sources in an organization in addition to the kinds of data that are accessible in the system. In this way, collections from key custodians and (non-custodial data sources) NCDS may be prioritized, accelerating delivery of key information critical for effective early case assessment and resource allocation. The project manager may facilitate viewing and reporting on discovery activity at custodian and data source level, including activity with electronic documents and records management (EDRM) tools, highlighting prior collection, processing, review and production efforts.

Project manager 208 may further implement version control, change management, and automatically generated audit trails. In particular, the project manager may facilitate history management by recording all of a team's discovery efforts, reducing risk exposure and eliminating wasteful re-collections. Reports delivered by the project manager may deliver insight into data sources and custodian activity past and present.

In combination with other modules of the plurality of modules 204, including but not limited to visualization module 206, project manager 208 may allow access to third-party tools (e.g., via third party or other applications 222) and resource teams' project progress through a single platform. In this way, discovery trends and phase details may be analyzed. Advanced reporting and dashboards described herein may deliver critical information. It will be appreciated, however, that project manager 208 may facilitate additional functions outside the realm of ESI, such as paper evidence collections and custodian depositions.

In some examples, project manager 208 may maintain activity logs that track user and system activity to aid, for example, in trial preparation, defensibility, and audits. In some embodiments, creation and/or saving of the activity logs may be automatic.

Project manager 208 may help facilitate the cross-team, role-based workflow shown in FIG. 8. As described below with reference to FIG. 8, the project manager may particularly facilitate the creation of one or more projects by a coordinator in an effort to divide and distribute work to satisfy a project request such as a request to perform e-Discovery and collect ESI matching user-supplied criteria, for example. The project manager may be used to at least partially manage the project request throughout the lifetime of the request.

Effective e-discovery management is greatly dependent on consistent, repeatable processes and workflows. Workflows specifically define the interplay among people, processes, and technology as e-discovery projects move from start to finish. This interplay is extremely important in a process that involves a variety of stakeholders (legal, IT, records management, etc.), a bevy of minute tasks, and multiple departments. Project manager 208 may provide an end result that is a proactive, well-defined process with clearly defined objectives, timelines, and assignments that serves as a framework for establishing goals, setting expectations, and monitoring performance at various levels during the matter, thus assuring timely completion of each stage of e-discovery in a defensible manner.

Legal hold manager 210 may be configured to automate and manage a legal hold process. As part of a legal hold process, the legal hold manager may execute a multitude of actions, including but not limited to sending and managing notifications that succinctly convey the actions required for a legal hold or data map request, for example. In some scenarios, a plurality of notifications may be sent by the legal hold manager via a common platform, making it easier to understand the notifications and comply with the required actions. Thus may assist in complying with Federal Rules of Civil Procedure (FRCP) requirements and due diligence required in litigation, for example, and help automatically prevent spoliation of ESI.

Interview manager 211, shown as being integrated within legal hold manager 210, may be configured to create, manage and automate interviews and surveys for purposes including but not limited to depositions, 26f preparation, data mapping projects, custodian identification, data preservation or collection, and other processes where critical information is needed to drive projects forward.

In some examples, interviews may be automatically created by interview manager 211 in response to creation of a legal hold. The interviews may comprise questionnaires that may be customized, and in some embodiments, autopopulated with custodian and other user data via integration with HR systems (e.g., HR database 226), reducing manual work. Templates, described above, may be used to repeat similar types of interviews, and interviews may be created based on various answer types pulled from a questionnaire library.

Users may interact with interviews at various stages of their evolution in different ways. Interview creators, for example, may impose deadlines by which answers and other information is to be received, schedule interviews, and create notifications, reminders, and escalation notices if sufficient compliance is not achieved. In particular, unresponsive custodians may be escalated to their supervisors. Reminders and escalations may be suspended and resumed at an interview and participant level, however. Information gathered by an interview or survey may trigger other actions in enterprise management system 200, including but not limited to including in-person interviews, legal hold notifications, or data map refresh requests. Further, such information may be tabulated relational database or other suitable data structure for flexible analysis and reuse. A dashboard specific to interviews, presented via visualization module 206 for example, may be provided to succinctly summarize the interview status and progress, and enable escalation if required. The dashboard may indicate all custodians whose compliance has yet to be fulfilled, for example. It will be appreciated that interviews and surveys may be distributed and conducted in various suitable manners—e.g., interviews may be distributed via SMTP or other email integration via network 130 and conducted electronically, or may be conducted over the phone or in-person.

Interview manager 211 may facilitate a thorough custodian interaction with an interview and related tasks. For example, custodians may ask questions and receive answers regarding obligations and compliance related to an interview. Custodian interaction may be mandated, however, in which case the interview manager may require a custodian to acknowledge an interview (or legal hold, data map request, etc.), confirm that they understood it, and facilitate communication with the legal team if clarification is needed. In some embodiments, custodians may have the ability to add and associate data sources with a legal hold.

Custodian acknowledgment may be handled in a variety of manners. For example, interview manager 211 may implement proxy acknowledgment in which acknowledgments may be captured by proxy (e.g., on behalf of high-profile custodians) through a third party. Proxy acknowledgment may comprise sending a separate notice to implicated high-profile custodians. Self-acknowledgment may also be carried out, which may facilitate compliance with European Union (EU) privacy laws. Moreover, custodians may be able to self-certify the data sources and data types for which they are responsible, and also upload relevant documents for a legal hold or data mapping request when appropriate.

Legal hold manager 210 may execute a variety of actions based on participant responses to interviews and surveys issued by interview manager 211. Such actions may assist with custodian release, preservation, and collection performed by enterprise management system 200.

In some embodiments, hold notifications (and other notifications) issued by legal hold manager 210 may be updated based on changes to data held in HR database 226. For example, HR database 226 may store and associate a plurality of parameters with a plurality of custodians. Issuance of hold notifications may thus be controlled in response to changes to such parameters, including but not limited to change in employment status, termination, paid leave, change in job title, change in job responsibilities, etc. Issuance of hold notifications may be controlled via user input or by other aspects of enterprise management system 200, however. Moreover, publication status, used herein to refer to whether a custodian is notified of a legal hold (or other action) in which they are implicated, may be updated based on changes to the aforementioned HR database parameters.

In some embodiments, issuance of legal hold notifications, release notifications (e.g., indicating that a custodian is no longer subject to a legal hold), and other notifications to a given custodian may be controlled based on whether that custodian has associated therewith a publication parameter indicating that the custodian has a non-publication or non-published status—in other words, that the custodian is not to be notified of the legal hold. In this way, legal hold issuance or release may be handled “silently”. For example, the legal hold manager may involve custodians in a hold from issue until release, without sending any notification (e.g., issue, re-issue, escalation and release notices). Under such conditions, the custodians may remain involved in the hold, and tracked, monitored, etc., without receiving notifications. Silent handling in this way may be a function of one or more parameters found in HR database 226 described above. In other examples, a non-publication status may be assigned to a custodian or other individual if it is desired to avoid sending repeated notifications to that custodian/individual. Assignment of the non-publication status may also be useful in instances in which the maintenance of data associated with a custodian is desired even after the custodian is released from a hold, as sending a release notification may cause the custodian to delete the data. In this example, the custodian remains under the impression that the hold still applies.

As an example use case, a legal hold for a legal matter may implicate a group of custodians—e.g., five custodians participating in the legal hold. A subset of the custodians may have a published (e.g., publication status allowing issuance of notifications) status whereas the other custodians may have an unpublished (e.g., non-publication preventing issuance of notifications) status. If a first, second, third, fourth, and fifth custodian are participating in a legal hold associated with a matter involving an investigation of the fifth custodian, then the first, second, third, and fourth custodians may be assigned a published status and may receive certain notifications associated with the legal hold. However, the fifth custodian may be assigned an unpublished status and may not receive certain notification associated with the legal hold. However, if those same five custodians are concurrently associated with another legal matter, they may each be designated as a published custodian with respect to that matter and all will receive notifications via the system.

FIG. 4 shows a non-limiting example of a GUI 400 that may be used to assign a publication or non-publication status to one or more custodians. In this example, GUI 400 displays a plurality of custodians (a subset of which are shown in FIG. 4), along with a plurality of parameters associated with the custodians, including last name, first name, GUID, title, department, and publication status. Here, an “active” status corresponds to a publication status—i.e., a status indicating that notifications are to be issued and received. In this way, a user managing legal holds may quickly and easily control publication and non-publication statuses for a plurality of custodians from a central location.

It will be appreciated that legal hold notifications, and other notifications including but not limited to release, reminder, and escalation notifications, may be issued in various suitable manners. For example, such notifications may be issued through email. The emails may enable one click (or other suitable user interaction) navigation from the notification to a variety of features. In some embodiments, email addresses stored in a custodian directory in custodian manager 212 may be used as a basis on which to issue notifications. Further, in the course of constructing a legal hold, legal hold manager 210 in some embodiments may suggest potentially relevant custodians to one or more custodians already selected for the legal hold, which may accelerate the notification and collection processes. Potentially relevant custodians may be derived from the custodian directory in the custodian manager, for example.

Legal hold manager 210 may include other features. For example, the legal hold manager may present a GUI by which escalations, notification resends, and hold releases may be issued with one click (or other suitable engagement with the GUI) from a central location. The GUI may also track custodian information and communication. In some embodiments, the GUI may be web-based and matter-centric. Moreover, this and other information (e.g., legal hold and other task assignment, escalations, reminders, releases, etc.) may be tracked over time to form historical custodian and matter data that may be searched according to various parameters including data ranges. For example, all legal hold escalations issued between a first date and a second date may be discovered in this way.

Legal hold manager 210 may also interface with project manager 208 to utilize templates to facilitate rapid legal hold creation, which may increase consistency of the legal hold process. In some examples, some templates may be marked as “private”. Private templates may restrict access to sensitive information for the purposes of privacy and security. Whether or not hold notifications are derived from templates, the hold notifications may be customized based on user input, however. Moreover, the legal hold manager may implement dynamic tags which may be used to propagate real-time information throughout hold notifications.

Legal hold manager 210 may be further configured to preserve data, for example in order to comply with litigation. The legal hold manager may preserve written communication (e.g., email) and data hold requests, for example. The legal hold manager may also preserve data in two manners: at a data source and via collection. In the first manner, data may be preserved at the source on which it resides by preventing its deletion or medication at the source. In the second manner, which may be performed alternatively or additionally to the first manner, data is preserved by copying the data from its data source to a storage medium (e.g., 216) where the data cannot be deleted or otherwise modified.

FIG. 5 shows a flowchart illustrating an exemplary method 500 for preserving data. In particular, method 500 is shown as being executed on enterprise management system 200 including interfaces with an ESI source 502 and a third party 504. As shown, in the method the enterprise management system may send an email notification to the third party. The third party may modify legal hold criteria and send the criteria to an ESI source. The third party may also initiate a legal hold and send the hold to the ESI source. The management system may send requests to the ESI source to get legal hold jobs and, in response, the ESI source may send progress updates and metrics to the management system. For example, notifications may be sent indicating an in-progress status or a completed status.

Returning to FIG. 2, legal hold manager 210, along with other modules of the plurality of modules 204 in enterprise management system 200, may implement an open architecture, permitting customization and integration with other data preservation and storage technologies. For example, integration with third-party electronic discovery reference model (EDRM) tools such as Symantec Enterprise Vault and Discovery Accelerator, Recommind InSite, StoredIQ, Informatica and Clearwell, as well as other existing enterprise applications, may be possible. Integration in this way may bridge the gap between legal departments and IT, and may simplify the process for a legal department to pass instructions to IT to safely lock down data so custodians can continue mission-critical job tasks.

Legal hold manager 210 may implement other functionalities. For example, the legal hold manager may facilitate robust tracking and auditing via activity logs and chain-of-custody reports. The legal hold manager may also form lists of custodians and data sources implicated in a hold. As described above, the legal hold manager, in combination with visualization module 206, may collect and present all information relating to a legal hold via a single dashboard, which may help integrate communication between custodians and legal teams. Moreover, the legal hold manager may facilitate the searching and linking of two or more holds (or matters) to one another and to custodians and data sources. In this way, legal teams may have the capability to find all data related to a particular matter or matter type, enabling them to leverage available information, and reducing spoliation risk.

Other features may result from the combination of legal hold manager 210 with visualization module 206. For example, user may view the number of active and inactive legal holds for each data source and custodian via intuitive graphical display. Users may drill down to view additional details about the active legal holds and hold histories. Further, user may monitor compliance data map, interview, and legal hold requests to understand levels and completion and areas where escalation may be needed.

FIG. 6 shows a flowchart illustrating an exemplary method 600 for performing data collection as part of a legal hold. At 602, a legal hold is created, and, at 604, custodians and NCDS are scoped to the legal hold to determine who is implicated by the legal hold. At 606, the legal hold is issued. At 608, it is determined whether the legal hold creator has clicked “Collect”, a user interface control operable to initiate data collection according to the legal hold. If the creator has not clicked “Collect”, data collection is not planned at 610. If the creator has clicked “Collect”, the custodians and NCDS whose data is to be collected are selected at 612. Then, at 614, data collection according to the legal hold is planned. Data collection may be carried out according to a suitable timeframe that accommodates the dynamics of the legal hold. Finally, at 616, the collection is submitted to initiate data collection. The collection may be submitted by the legal hold creator or another user.

Continuing with FIG. 2, custodian manager 212 may be configured to facilitate custodian management. The custodian manager may allow access to all custodian and data steward information from a centralized location. As described above, custodian manager 212 may include a custodian directory comprising a plurality of custodian profiles relating to custodians, wherein each custodian profile includes one or more parameters associated with a given custodian. The one or more parameters may include a publication parameter (e.g., status identifier) identifying whether the custodian should be notified of a legal hold (or other event) in which they are implicated. Specifically, a non-publication parameter associated with a given custodian indicates that the custodian should receive legal hold (or other) notifications, and is configured to enable managing and tracking of the custodian in the directory without notifying the custodian.

The custodian directory may comprise a plurality of tables comprising personalized data relating to the custodians, including name, title, notification dates, e-mail address, information relating to storage locations in network 130 associated with the custodians, etc. Further, changes to these and other parameters may be detected; for example, change in employment status, termination, paid leave, job title, job responsibilities, etc. may be used to drive custodian interaction.

In some embodiments, the custodian directory may be further configured to interface with HR database 226 and update publication parameters based on periodic accesses to the HR database responsive to changes to the one or more custodian parameters described above. In other embodiments, updating may be automatic upon receiving updates from the HR database. Such a configuration may obviate the problem of IT administrators having to periodically and manually update custodian information.

In some examples, changes that occur to custodian profiles in the custodian directory may be recorded over time such that the custodian profiles comprise historic information relating to the custodians, including historic information regarding previous publication and non-publication statuses.

FIG. 7 shows a flowchart illustrating an exemplary method 700 for issuing custodian notifications based on publication parameters. First, at 702, a legal hold is created. Then, at 704, custodians and NCDS are scoped to determine a status of the custodians with respect to the legal hold. If, at 706, the custodian or data steward is published, then at 708 a notification is sent and the custodian status is updated to “Issued.” At 710, a reminder may be sent to the custodian or data steward for follow-up. At 712, the custodian or data steward legal hold status may be updated based on reminders and acknowledgements. At 714, the method includes determining whether the custodian or data steward is to be released silently. If the custodian or data steward is to be released silently at 714, then at 716 custodian status is updated to “released” but a release notice is not sent to the custodian. However, if the custodian or data steward is not to be released silently at 714, then at 726 custodian status is updated to “released” and a release notice is sent to the custodian or data steward.

However, if at 706, the custodian is not published, then at 718 a notice is not sent to the custodian and the custodian status is changed to “unpublished.” In other words, the publication parameter associated with the custodian or data steward is set to non-published. Then, at 720, a reminder notice is not sent to the custodian. At 722, it is determined whether to issue a notice to unpublished custodians. If yes, then the method proceeds to 708 to send a notification as described above. However, if no at 722, then at 724 the custodian is silently released at the end of the legal hold. Such an approach may provide legal team visibility at all stages of this process.

Custodian manager 212 may help facilitate the cross-team, role-based workflow of FIG. 8 as well as the methods shown in FIGS. 9 and 10, for example by facilitating access to and retrieval of custodian information for an e-Discovery project in which ESI associated with specified custodians and matching certain criteria may be automatically collected.

Returning to FIG. 2, data mapping module 214 may be configured to perform identification of ESI as it resides across system 100 and to create a data map stored in data map database 216. Developing a data map that can grow and change with the system may include capturing details about how potentially relevant ESI is used, stored, preserved, and accessed for a specific matter or, more commonly, across an entire litigation portfolio. Rich and complete data capture may be provided via integration with third party or other applications 222 including HR and asset management systems, IT infrastructure and EDRM tool integrations, and other e-discovery, legal hold, and litigation management solutions. In some embodiments, building and maintenance of the data map may be user-initiated. For example, periodic reminders may be issued to prompt a user to initiate mapping of data. Data mapping according to a predetermined schedule or in response to data updates in enterprise management system 200 are contemplated as well, however.

Data mapping helps an organization build and maintain an evergreen data map, minoring a company or other institution's information base as it evolves. Data mapping module 214 may include various visualization features, e.g., coupled with visualization module 206, to provide a rich visualization and cross-functional collaboration capabilities to facilitate a structured inventory for identifying, collecting and producing relevant ESI, providing an advantage in meet-and-confer preparations. In particular, visualization features resulting from coupling the data mapping module with the visualization module may include visibility into and control over identified data sources and information, including real-time insight into data mapping.

By building a data map, institutions and organizational departments, such as IT and inside counsel, may have increased leverage with which to negotiate favorable scopes of discovery and have a more realistic understanding of how burdensome it will be to comply with discovery requests. Moreover, smarter litigation response to e-discovery and regulatory compliance requests and company internal investigations may be facilitated.

Data mapping module 214, and data map database 216, may help facilitate the cross-team, role-based workflow of FIG. 8, for example. Particularly, data mapped by the data mapping module may be used to automatically discover and collect data based on user-specified criteria as part of an e-Discovery project, for example.

Predictive module 218 may be configured to employ predictive technologies in order to assist users in the prioritization of documents for review, among other purposes (e.g., anticipate e-Discovery requests). Because of the sheer amount of potentially relevant ESI and Big Data involved in a typical e-discovery request, it is often prohibitively difficult for humans to manually review each document for relevancy. Human error in judging the relevance of documents further compounds the difficulty of document review. As such, the predictive module may potentially reduce the cost of review. In some embodiments, the predictive module may employ machine learning to prioritize documents for review.

ESI collection/processing module 213 may be configured to facilitate collection of ESI in a typical EDRM process. For example, data distributed across and residing on various devices within network 100 may be collected. Further, metadata associated with the data may be collected.

ESI analyzer module 217 may be configured to facilitate analysis of ESI in a typical EDRM process. For example, the analyzer module may assist with determining the relevance of collected ESI, establish hierarchies regarding the data (e.g., within a department), and analyze the data in view of litigation history. The analyzer module may further review data sources that store ESI and particularly whether data stored thereon can be modified or destroyed. Finally, the analyzer module may determine potential custodian behavior including potential compliance with tasks (e.g., legal hold, data map request, etc.).

ESI production module 219 may be configured to facilitate production of ESI and other data in a typical EDRM process. For example, the production module may facilitate production in compliance with FRCP rules including rule 26(f), analyze data formats (e.g., whether they are native, near-native, images, paper, etc.), analyze production requirements (e.g., file formats, whether text should be searchable), and prepare and copy data to suitable media (e.g., optical media such as CD, DVD, HD-DVD, Blu-Ray Disc, etc.; magnetic memory such as hard-disk drive, floppy-disk drive, tape drive, MRAM, etc., among others).

Internal/legacy systems 221 may include other modules and/or systems internal to departments or organizations, and/or legacy systems. For example, the internal/legacy systems may comprise computing systems, data sources, and/or operating systems or other software. In this way, hardware and software that may otherwise be outdated and/or incompatible may be integrated with enterprise management system 200 for involvement with the approaches described herein.

As described above, enterprise management system 200 may interface with third party or other applications 222. The third party or other applications may include IT systems, content management applications, and EDRM tools, for example. For example, the system may perform integrations through web services, and/or data transfer (e.g., of documents, spreadsheets, media files, etc.) to ensure that users are always alerted when key changes occur in other systems. In some examples, the enterprise management system may be seamlessly integrated with HR systems, asset management, matter management, single sign-on, Lightweight Discovery Access Protocol (LDAP), and other critical IT systems. These connectors capture and translate data, dispatch work to other applications, correlate activities, and summarize results so e-discovery teams can efficiently complete projects and avoid ambiguity. In addition to centralizing access to critical organizational data, these connectors facilitate inspecting and searching files and metadata to help evaluate collection efforts and locate responsive information. These data source connectors play a critical role in later stages of the discovery process. This configuration may provide an extensible, flexible framework and robust software adapters that enable organizations to leverage existing IT investments, gain visibility into other EDRM tools, and collect ESI from diverse data sources

Review and processing manager 224 may be configured to facilitate the processing and review steps of a typical EDRM process in a combined module. For example, the review and processing manager may determine, on an item-level, what data is present in a volume of collected data (e.g., a collection of ESI relating to one or more matters stored in database 216). Metadata associated with the data may be recorded prior to processing, and data deemed irrelevant to the task at hand may be discarded. Data may also be extracted and/or decompressed by the review and processing manager.

The review and processing manager may facilitate other functions. For example, the review and processing manager may implement concept-based searching of data and not just keyword searching. Pattern recognition may also be utilized to reduce the burden of review, and tools, within the plurality of modules 204 and/or within third party or other applications 222, may be recommended based on analysis of the data.

As shown and described, enterprise management system 200 may provide a streamlined, fully defensible integrated system that delivers cost savings and complete visibility at each stage of a typical EDRM process, while significantly reducing the risk of process failures and data spoliation that may arise from information transfers between disparate steps using a non-integrated approach.

In some embodiments, enterprise management system 200 may comprise memory and at least one processor in communication with the memory, the memory comprising instructions executable by the at least one processor to store a custodian directory comprising a plurality of custodian profiles relating to custodians, each custodian profile indicating whether an associated custodian is to be notified that the associated custodian is being tracked. In some examples, the enterprise management system may further comprise one or more storage devices storing electronically stored information, and an electronic discovery management server in communication with the one or more storage devices. In some examples, the enterprise management system may further comprise a network communicatively coupling the electronic discovery management server to one or more storage devices. In some examples, the instructions may be further executable to notify a given custodian that the given custodian is being tracked if a custodian profile associated with the given custodian includes a publication parameter indicating that the given custodian has a published status. In some examples, the instructions may be further executable to perform one or more actions relating to a given custodian without notifying the given custodian of the one or more actions if a custodian profile associated with the given custodian indicates that the given custodian is not to be notified that the given custodian is being tracked. In some embodiments, the enterprise management system may further comprise a custodian manager for interfacing with the custodian directory. In some embodiments, the enterprise management system may further comprise a human resource database communicatively coupled with the custodian manager via a network, the custodian directory populated based on data in the human resource database.

In some embodiments, enterprise management system 200 may further comprise a human resource database communicatively coupled with the custodian manager via a network, the custodian manager updating the plurality of custodian profiles responsive to updates to the human resource database. In some examples, each of the plurality of custodian profiles includes one or more of a name, title, notification date, email address, and a storage location of electronically stored information. In some examples, the enterprise management system may further comprise one or more storage devices storing electronically stored information and an electronic discovery management server in communication with the one or more storage devices, the electronic discovery management server for sending hold notifications to custodians subject to a hold using email addresses stored in respective custodian profiles of the custodian directory. In some examples, the enterprise management system may further comprise a human resource database and an electronic discovery management server in communication with the human resource database, the electronic discovery management server for issuing hold notifications to custodians subject to a hold, the hold notifications updated based on updates received from the human resource database. In some examples, the electronic discovery management server may be configured to record within the plurality of custodian profiles changes that occur to information in the custodian profiles over time such that the plurality of custodian profiles comprise historic information relating to the custodians, including historic publication statuses.

In some embodiments, enterprise management system 200 may include memory and at least one processor in communication with the memory, the memory storing instructions executable by the at least one processor to store a custodian directory comprising a plurality of custodian profiles relating to custodians and to interface the management system with a human resource database and an electronic discovery management server in communication with the human resource database via the network. In some examples, interfacing the management system with the human resource database includes issuing hold notifications based on data stored in the human resource database. In some examples, interfacing the management system with the human resource database includes tracking publication statuses of the custodians, each publications status indicating whether an associated custodian is to be notified that the associated custodian is being tracked.

Turning now to FIG. 8, a flowchart illustrating a method 800 for facilitating a cross-team, role-based workflow for task management is shown. As described in further detail below, method 800 may be executed on enterprise management system 200 using one or more of the plurality of modules 204. Although method 800 is described with reference to particular organizational members, roles, and projects (e.g., e-Discovery), it will be appreciated that these examples are provided for the sake of understanding and that the method may be adapted for other members, roles, and projects.

At 802, at an initiation stage of method 800, a project request is sent (e.g., via enterprise management system 200) by a member of a legal/compliance team to a business coordinator (or e-Discovery coordinator) who receives the request. Formulation of the project request may include retrieving data from project manager 208 of enterprise management system 200, for example. In the depicted example, the project request is a request to perform e-Discovery. The project request may include criteria such as one or more of a custodian list (which may include custodians scoped as in methods 600 and 700 of FIGS. 6 and 7, respectively) having custodians whose data is to be discovered/searched, one or more data types to be searched for (e.g., word processing documents, emails, multimedia files, particular file extensions, etc.), one or more actions to be performed on discovered data (research, preserve, collect, track), a scope (e.g., a date range in which data is to be returned such as a date range specifying data creation and/or modification dates), special instructions, and optionally approval. The actions to be performed on discovered data may include leveraging data mapping module 214 and/or data map database 216 for research, and legal hold manager 210 for preservation and/or collection, for example. As one non-limiting example, a project request may specify that systems (e.g., data sources) associated with a particular custodian are to be searched for word processing documents and emails created during the year 2011, and that matching data be collected.

At 804, at a planning stage of method 800, the business coordinator plans the project request. The business coordinator may particularly provide or deny approval of the request if it was included in the request, accept the scope of the request, and assign work required by the request to a discovery coordinator (or collection coordinator), labeled in FIG. 8 as “On/Off site IT team”. Enterprise management system 200 may assign the required work to the discovery coordinator based on input received from the business coordinator.

At 806, at an execution stage of method 800, the discovery coordinator performs the work to which they are assigned by creating one or more projects in accordance with the project request. To do so, the discovery coordinator receives the project scope (e.g., the parameters specified in the request above including but not limited to the custodian list, data types, special instructions, etc.). In some examples, the discovery coordinator may in turn assign projects to one or more collection/preservation teams in accordance with the request. For example, enterprise management system 200 may assign the projects to the one or more collection/preservation teams based on input received from the discovery coordinator. In this way, the work is performed by dividing the work into projects and assigning the projects. The discovery coordinator may further update deliverables (e.g., completed e-Discovery request), assign teams to update the deliverables, provide issues relating to the request if they exist, and update project checklists if any exist, which may include accessing project manager 208 as described above.

At 808, at a quality control (QC) stage of method 800, deliverables (e.g., the one or more created and assigned projects) resulting from the execution state may be validated by a QC team, which may occur prior to external communication. The QC team may receive one or more updates from the execution stage and perform quality checks in response. To perform quality checks, the QC team may use internal (e.g., within enterprise management system 200) and/or external systems. The QC team may further provide issues if they exist and update a status indicating the condition of quality control, referred to herein as a quality control status.

At 810, at a delivery stage of method 800, details regarding project deliverables (e.g., data collection resulting from the e-Discovery request) verified by the QC team are received by a delivery team/vendor. Enterprise management system 200 may receive one or more quality control updates (e.g., validation) from the QC team and send the updates to the delivery team/vendor, for example, and may further transfer data from the delivery team/vendor to the discovery coordinator based on input received from the delivery team/vendor. The delivery team/vendor may particularly track progress using dashboards and/or reports (e.g., presented via visualization module 206), resolve issues if any exist, validate deliverables (e.g., data collected in response to the e-Discovery request), and initiate subsequent requests as required. The subsequent requests may be received by enterprise management system 200, for example.

Turning now to FIG. 9, a flowchart illustrating a method 900 for creating a project request is shown. Method 900 may be used to create a project request as part of method 800 of FIG. 8, for example. At 902 of the method, a matter may be created by a member of a legal/compliance team. Matter creation may include access to project manager 208 of enterprise management system 200, for example. At 904, one or more requests may be created by the legal/compliance team member. In the depicted example, n requests (request 1, 2, and n) are shown. At 906, request 1 (and request n) may be sent to an approver to be approved or denied. If the requests are denied (No), the method proceeds to 908 where the legal/compliance team member is notified of the denial and that the denied requests should be edited, and in response, the team member resubmits the edited requests as at 904. If the requests are approved (Yes), however, the method proceeds to 910 where other recipients receive notification of the requests. Next, at 912 of the method, a business coordinator reviews the requests. If the business coordinator does not approve the scope of the requests (Cancel), the method returns to 908. If the business coordinator does approve the scope of the requests (Assigned), the business coordinator assigns work to carry out the request by creating one or more projects (e.g., project 1.1, 1.2, . . . 1.n for request 1, project n.1, n.2, . . . n.n for request n) at 914.

Turning now to FIG. 10, a flowchart illustrating a method 1000 for managing projects. Method 1000 may be used to manage projects created via method 900 of FIG. 9 as part of method 800 of FIG. 8, for example. In the depicted example, four projects are shown as being created following approval of a project request: a research project, preservation project, collection project, and a delivery project.

For the research project, at 1002 the research project is created by a discovery coordinator. Next, at 1004 custodians implicated by the research project are researched (e.g., discovered in part based on access to the custodian directory in custodian manger 212 of enterprise management system 200) and research details regarding the project are updated by the discovery coordinator (in which case the discovery coordinator assigned himself or herself to the project) or another team member. Next, at 1006, a quality check is performed by a QC team. Next, at 1008, it is determined whether the QC team accepts the research details. If the research details are not accepted (No), the method returns to 1004. If the research details are accepted (Yes), the method proceeds to 1010 where the project is completed.

For the preservation project, at 1012 the preservation project is created by the discovery coordinator. Next, at 1014, custodians/NCDS are imported from the research project by the discovery coordinator. Next, at 1016, data is preserved and details regarding the preservation project are updated by the discovery coordinator or other team member. Next, at 1018, a quality check is performed by the QC team. Next, at 1020 it is determined whether the QC accepts the preservation details. If the preservation details are not accepted (No), the method returns to 1014. If the preservation details are accepted (Yes), the method proceeds to 1022 where the project is completed.

For the collection project, at 1024 the collection project is created by the discovery coordinator. Next, at 1026, custodians/NCDS are imported from the research project by the discovery coordinator. Next, at 1028, data is collected and details regarding the collection project are updated by the project coordinator or other team member. Next, at 1030, a quality check is performed by the QC team. Next, at 1032 it is determined whether the QC accepts the collection details. If the collection details are not accepted (No), the method returns to 1026. If the collection details are accepted (Yes), the method proceeds to 1034 where the project is completed.

For the delivery project, at 1036 the delivery project is created by the discovery coordinator. Next, at 1038, custodians/NCDS are imported from the collected project by the discovery coordinator. Next, at 1040, a quality check is performed by the QC team. Next, at 1042, it is determined whether the QC team accepts the delivery details. If the delivery details are not accepted (No), the method returns to 1038. If the delivery details are accepted (Yes), the method proceeds to 1044 where the delivery details are updated by the QC team. Next, at 1046, the project is completed (e.g., by delivering the collected data in the collection project to the discovery coordinator).

Thus, as shown, each of the research, preservation, collection, and delivery projects may include respective quality checks and approvals performed by the QC team to increase compliance with the project request.

Note that the example systems and programs described herein may represent various acts, operations, or functions, each of which may be performed in the sequence described, in parallel, or in some cases omitted. Likewise, the order of processing is not necessarily required to achieve the features and advantages of the example embodiments described herein, but is provided for ease of illustration and description. One or more of the described program actions, operations, and/or functions may represent code to be programmed into a non-transitory computer readable storage medium in enterprise management system 200, including but not limited to methods 500, 600, 700, 800, 900, and 1000 of FIGS. 5, 6, 7, 8, 9, and 10, respectively.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. On a computing device, a method for facilitating a cross-team, role-based workflow for task management, comprising:
sending a project request to a business coordinator, the project request received from a legal/compliance team member;
assigning work required by the project request to a discovery coordinator based on input received from the business coordinator;
performing the work required by the project request by assigning one or more projects to one or more collection/preservation teams based on input received from the discovery coordinator.

2. The method of claim 1, further comprising:
receiving validation of the one or more projects from a quality control team; and
sending the validation to a delivery team/vendor.

3. The method of claim 2, further comprising transferring data to the discovery coordinator based on input received from the delivery team/vendor.

4. The method of claim 2, further comprising receiving subsequent project requests from the delivery team/vendor.

5. The method of claim 2, further comprising updating a quality control status based on the received validation.

6. The method of claim 1, wherein the project request is an e-Discovery request for collection of electronically-stored information matching criteria specified by the project request.

7. The method of claim 6, wherein the criteria include a custodian list, one or more data types to be searched, and a date range.

8. The method of claim 1, wherein the custodian list is retrieved from a custodian directory in a custodian manager.

9. The method of claim 1, wherein the work required by the project request is assigned to the business coordinator if an approver approves the project request, the legal/compliance team member notified to edit the project request if the approver denies the project request.

10. The method of claim 1, wherein the one or more projects include a research project including discovering custodians implicated by the project request, a data preservation project including preserving data associated with the custodians, a data collection project including collecting the data associated with the custodians, and a delivery project including delivering the data associated with the custodians to the discovery coordinator.

11. The method of claim 10, wherein each of the research, preservation, collection, and delivery projects include respective quality checks and approvals performed by quality control team.

12. On a computing device, a method for collecting electronic discovery data from custodians, comprising:
maintaining a custodian directory comprising a plurality of custodian profiles, each custodian profile associated with a custodian and comprising information relating to a storage location in a computing network associated with the custodian as well as a status identifier as to whether the custodian has a non-published status;
receiving an electronic discovery request that identifies a first custodian;
in response to receiving the electronic discovery request, accessing a custodian profile associated with the first custodian to determine a storage location associated with the first custodian;
automatically collecting data stored at the storage location;
storing the collected data on a storage device; and
tracking the collected data without notifying the first custodian of the tracking if the custodian profile associated with the first custodian includes a non-publication parameter.

13. The method of claim 12, further comprising populating each of the plurality of custodian profiles based on data stored in a human resource database.

14. The method of claim 13, further comprising updating each of the plurality of custodian profiles based on changes to the data stored in the human resource database.

15. The method of claim 12, further comprising notifying the first custodian of the tracking if the custodian profile associated with the first custodian includes a publication parameter.

16. A system for facilitating an electronic discovery workflow, comprising:
memory; and
at least one processor in communication with the memory, the memory comprising instructions executable by the at least one processor to:
maintain a custodian directory comprising a plurality of custodian profiles, each custodian profile associated with a custodian and comprising information relating to a data source in a computing network associated with the custodian as well as a status identifier identifying whether the custodian has a non-published status;
send an electronic discovery request to an e-discovery coordinator, the electronic discovery request received from a legal/compliance team member and identifying a first custodian;
assign the electronic discovery request to a collection coordinator based on input received from the e-discovery coordinator;
assign a collection project to one or more collection/preservation teams based on input received from the collection coordinator to thereby satisfy the electronic discovery request;
access a custodian profile in the custodian directory associated with the first custodian to determine a data source associated with the first custodian;
collect data stored in the data source associated with the first custodian;
send the collected data associated with the first custodian to the collection coordinator; and
track the collected data without notifying the first custodian of the tracking if the custodian profile associated with the first custodian includes a non-publication parameter.

17. The system of claim 16, wherein the collected data associated with the first custodian is validated by a quality control team prior to being sent to the collection coordinator.

18. The system of claim 16, wherein the instructions are further executable to assign a research project, a data preservation project, and a delivery project to the one or more collection/preservation teams based on input received from the collection coordinator.

19. The system of claim of claim 16, wherein the electronic discovery request includes criteria specifying other custodians having data to be collected, one or more data types to be discovered, creation and/or modification dates of the data, and one or more actions to be performed on data matching the criteria.

20. The system of claim 16, wherein the other custodians are retrieved by accessing a human resource database via a network.
